(19) United States
(12) Patent Application Publication
(10) Pub. No.: US 2023/0018745 A1
(43) Pub. Date: Jan. 19, 2023

(54) POWER STORAGE DEVICE

(71) Applicant: TOYOTA JIDOSHA KABUSHIKI KAISHA, Toyota-shi Aichi-ken (JP)

(72) Inventors: Kotaro Horiguchi, Toyota-shi Aichi-ken (JP); Shigeyuki Inoue, Toyota-shi Aichi-ken (JP); Shinichiro Mori, Okazaki-shi Aichi-ken (JP)

(73) Assignee: TOYOTA JIDOSHA KABUSHIKI KAISHA, Toyota-shi Aichi-ken (JP)

(21) Appl. No.: 17/864,002

(22) Filed: Jul. 13, 2022

(30) Foreign Application Priority Data
Jul. 19, 2021 (JP) 2021-118684

(51) Int. Cl. H01M 10/653; H01M 10/613; H01M 10/625; H01M 10/6568

(52) U.S. Cl. CPC H01M 10/653; H01M 10/613; H01M 10/625; H01M 10/6568; H01M 2220/20

(57) ABSTRACT

A power storage device comprises: a power storage stack; an accommodation case that has a bottom wall portion and accommodates the power storage stack therein; and an adhesive layer that has thermal conductivity and fixes the power storage stack to the bottom wall portion. The bottom wall portion includes a receiving portion that has a receiving surface on which the power storage stack is received, a lower wall portion located at a position lower in level than the receiving surface, and a connecting portion that interconnects the receiving portion and the lower wall portion. The adhesive layer includes a portion disposed between the receiving surface and the power storage stack, and a protruding portion that protrudes from the receiving surface to the connecting portion.

This nonprovisional application is based on Japanese Patent Application No. 2021-118684 filed on Jul. 19, 2021 with the Japan Patent Office, the entire contents of which are hereby incorporated by reference.

### BACKGROUND

### Field

The present disclosure relates to a power storage device mounted on a vehicle.

### Description of the Background Art

As a conventional power storage device, Japanese Patent Application Laying-Open No. 2019-125449 discloses a power storage device in which a cooler, a heat transfer member, and a power storage stack are accommodated in an accommodation case and disposed in this order from the side of a bottom wall of the case. The heat transfer member is sandwiched between the power storage stack and the cooler, and includes rubber particles and a resin having high thermal conductivity.

### SUMMARY

Generally, a power storage device in which a cooler, a heat transfer member, and a power storage stack are accommodated in an accommodation case, as disclosed in Japanese Patent Application Laying-Open No. 2019-125449, includes a fixing structure that fixes the cooler to the accommodation case and a fixing structure that fixes the power storage stack to the accommodation case.

In recent years, there is a demand for a power storage device to have large capacity, and a power storage module accommodated in a case has also been increased in size. In order to simplify the fixing structures or effectively utilize the space in the accommodation case, the cooler may be disposed outside the accommodation case.

In such a case, if the power storage stack is fixed to the bottom wall portion of the accommodation case with a thermally conductive adhesive layer without taking any measure, pressing the power storage stack against the accommodation case via the adhesive layer may deform the accommodation case or insufficiently press the accommodation case. Further, when dew condensation occurs in the accommodation case, the power storage stack may short-circuit.

The present disclosure has been made in view of the above problems, and an object of the present disclosure is to provide a power storage device that allows a simple configuration to be used to fix a power storage stack to an accommodation case appropriately and can suppress short circuit of the power storage stack when dew condensation occurs in the accommodation case.

A power storage device according to the present disclosure comprises: a power storage stack; an accommodation case that has a bottom wall portion and accommodates the power storage stack therein; and an adhesive layer that has thermal conductivity and fixes the power storage stack to the bottom wall portion. The bottom wall portion includes a receiving portion having a receiving surface on which the power storage stack is received, a lower wall portion located at a position lower in level than the receiving surface, and a connecting portion that interconnects the receiving portion and the lower wall portion. The adhesive layer includes a portion disposed between the receiving surface and the power storage stack, and a protruding portion protruding from the receiving surface to the connecting portion.

According to the above configuration, the power storage stack is fixed to the bottom wall portion of the accommodation case with the thermally conductive adhesive layer, and the power storage stack can be fixed with a simple configuration. Furthermore, fixing the power storage stack to the bottom wall portion such that the adhesive layer protrudes from the receiving surface allows the power storage stack to be pressed against and fixed to the bottom wall portion with a reduced pressing load loss. Thus, the power storage stack can be sufficiently pressed against the bottom wall portion. Further, the bottom wall portion having the receiving surface and the lower wall portion can have large rigidity and hence be prevented from deforming when the power storage stack is pressed against and fixed to the bottom wall portion.

In addition, when dew condensation occurs in the accommodation case, dew condensation water moves to the lower wall portion located at a position lower in level than the receiving surface. This can suppress short circuit of the power storage stack on the receiving surface due to dew condensation water.

In the disclosed power storage device, the power storage stack includes a plurality of power storage cells aligned in an alignment direction. In this case, the receiving surface may include a first portion on which the power storage stack has one side received in an intersecting direction intersecting the alignment direction, a second portion on which the power storage stack has the other side received in the intersecting direction, and a recess provided between the first portion and the second portion.

The above configuration allows air to escape to a gap between the recess provided between the first portion and the second portion and the power storage stack when the power storage stack is pressed against the adhesive layer. This can suppress formation of an air layer between the power storage stack and the adhesive layer. This can in turn suppress a decrease in heat transfer efficiency.

The disclosed power storage device further comprises a cooler that is disposed outside the accommodation case and cools the power storage stack. In this case, the cooler may include a cooling portion that has a cooling channel through which a cooling medium passes. In some embodiments, the cooling portion may be disposed in contact with a back surface of the receiving portion located on a side facing away from the receiving surface.

According to the above configuration, the receiving portion can be cooled efficiently by the cooling portion, and thereby the power storage stack disposed on the receiving surface can be cooled efficiently.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an exploded perspective view of a power storage device according to a first embodiment.

FIG. 2 is a partial cross section of the power storage device according to the first embodiment, showing one end side of a power storage stack.

FIG. 3 is an exploded perspective view of a power storage device according to a second embodiment.

FIG. 4 is a cross section of the power storage device according to the second embodiment on the side of a bottom wall portion of an accommodation case.

### DESCRIPTION OF THE EMBODIMENTS

Hereinafter, embodiments of the present disclosure will be described in detail with reference to the drawings. In the following embodiment, any identical or common component is identically denoted and will not be described redundantly.

### (First Embodiment)

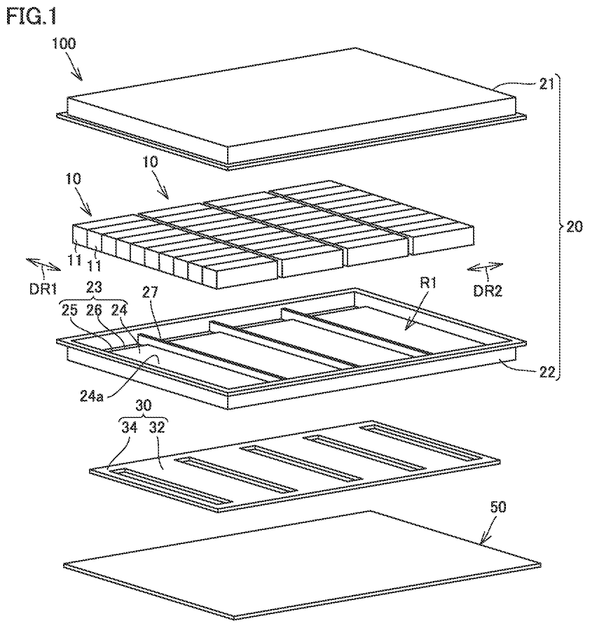

FIG. 1 is an exploded perspective view of a power storage device according to a first embodiment. With reference to FIG. 1, a power storage device 100 according to the first embodiment will be described.

Power storage device 100 is mounted on a hybrid electric vehicle that can travel by using power of at least one of a motor and an engine, or an electrically powered vehicle that travels by a driving force obtained from electric energy.

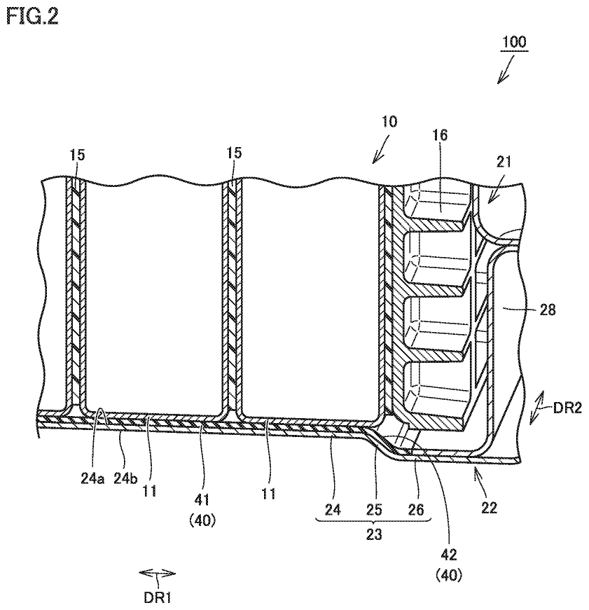

Power storage device 100 includes a plurality of power storage stacks 10, an accommodation case 20, a cooler 30, an adhesive layer 40 (see FIG. 2) and a share panel 50. The share panel means a cover panel.

Each of the plurality of power storage stacks 10 includes a plurality of power storage cells 11 aligned in an alignment direction DR1. When power storage device 100 is mounted on a vehicle, alignment direction DR1 is, for example, substantially parallel to the lateral direction of the vehicle. The plurality of power storage cells 11 are sandwiched in alignment direction DR1 by a pair of end plates 16 (see FIG. 2). A spacer 15 (see FIG. 2) is disposed between adjacent power storage cells 11.

The plurality of power storage stacks 10 are aligned in an intersecting direction DR2 intersecting alignment direction DR1 (more specifically, a direction orthogonal to the alignment direction). In the mounted state, intersecting direction DR2 is, for example, substantially parallel to the longitudinal direction of the vehicle.

Each of the plurality of power storage stacks 10 is fixed to a bottom wall portion 23 of accommodation case 20 by an adhesive layer 40 (see FIG. 2).

Power storage cell 11 is, for example, a secondary battery such as a nickel metal hydride battery or a lithium ion battery. The unit cell has, for example, a rectangular shape. The secondary battery may use either a liquid electrolyte or a solid electrolyte. The power storage cell may be a unit capacitor configured to be capable of storing electric power.

Accommodation case 20 accommodates the plurality of power storage stacks 10 therein. Accommodation case 20 includes an upper case 21 and a lower case 22. Upper case 21 is generally in the form of a box which opens downward. Lower case 22 includes bottom wall portion 23 and is generally in the form of a box which opens upward.

Bottom wall portion 23 includes, for example, a receiving portion 24, a pair of lower wall portions 25, and a pair of connecting portions 26. Receiving portion 24 has a receiving surface 24a on which power storage stack 10 is received. Receiving surface 24a is substantially flat. Receiving surface 24a is partitioned into a plurality of sections by a partitioning member 27 in the intersecting direction. Power storage stack 10 is disposed in each of the plurality of partitioned regions R1 partitioned by partitioning member 27.

The pair of lower wall portions 25 is provided at opposite ends of bottom wall portion 23 in the alignment direction. Lower wall portion 25 extends in a direction in which the plurality of power storage stacks 10 are aligned (i.e., intersecting direction DR2). Lower wall portion 25 is located at a position lower in level than receiving surface 24a. The heightwise direction is a direction parallel to a direction in which upper case 21 and lower case 22 are aligned, and corresponds to the vertical direction.

The pair of connecting portions 26 interconnects the pair of lower wall portions 25 and receiving portion 24. The pair of connecting portions 26 is curved to be positionally lower in level toward an outer side in the alignment direction.

Cooler 30 is a device that cools the plurality of power storage stacks 10. Cooler 30 is disposed outside accommodation case 20. Specifically, cooler 30 is disposed under bottom wall portion 23 of lower case 22.

Cooler 30 is made of a metal material such as aluminum. Cooler 30 includes a plurality of cooling portions 32 and a holding frame portion 34.

The plurality of cooling portions 32 are aligned in a direction parallel to intersecting direction DR2. Each of the plurality of cooling portions 32 is disposed at a position opposite to power storage stack 10 with bottom wall portion 23 interposed. Cooling portion 32 is disposed in thermal contact with a back surface 24b (see FIG. 2) of receiving portion 24 facing away from receiving surface 24a. Thus, receiving portion 24 can be cooled efficiently by cooling portion 32, and power storage stack 10 received on receiving surface 24a can be cooled efficiently via adhesive layer 40.

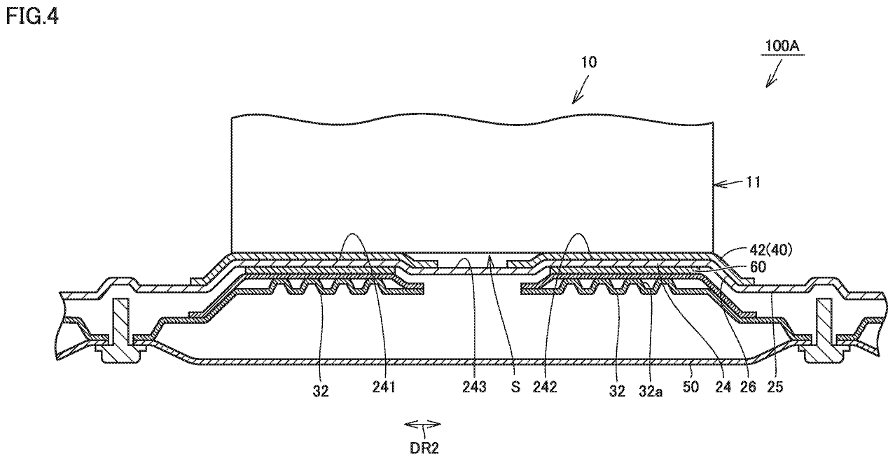

Cooling portion 32 has a cooling channel 32a (see FIG. 4) through which a cooling medium (water or the like) for cooling power storage stack 10 passes.

Holding frame portion 34 holds each cooling portion 32. Holding frame portion 34 is formed in an enclosure that surrounds the plurality of cooling portions 32. In the present embodiment, holding frame portion 34 is formed substantially in a rectangle. Each cooling portions 32 is connected at opposite ends in the alignment direction to holding frame portion 34.

Share panel 50 is disposed so as to cover cooler 30 at a lower side. Share panel 50 protects cooler 30. Share panel 50 is made of a metal material.

FIG. 2 is a partial cross section of the power storage device according to the first embodiment, showing one end side of the power storage stack. The one end side of power storage stack 10 is one end side in alignment direction DR1. In FIG. 2, cooler 30 and share panel 50 are not shown for convenience.

As shown in FIG. 2, bottom wall portion 23 is provided such that receiving portion 24 is generally located at a position higher in level than lower wall portion 25. This can enhance bottom wall portion 23 in rigidity.

Further, power storage stack 10 is received on receiving portion 24 such that end plate 16 is located above lower wall portion 25. A protection member 28 that protects power storage stack 10 is disposed at lower wall portion 25.

As described above, power storage stack 10 is fixed to bottom wall portion 23 by adhesive layer 40. Thus, power storage stack 10 can be fixed in a simple configuration.

Adhesive layer 40 is formed of a resin member having thermal conductivity. As adhesive layer 40, for example, an adhesive including silicone-based resin, acrylic resin, epoxy resin, or the like can be used. Adhesive layer 40 is formed by curing the adhesive.

Adhesive layer 40 includes a portion 41 disposed between power storage stack 10 and receiving surface 24a, and a protruding portion 42 protruding from receiving surface 24a to connecting portion 26.

When power storage stack 10 is fixed to bottom wall portion 23, an adhesive member is applied to receiving surface 24a and power storage stack 10 is pressed toward bottom wall portion 23. Pressing and thus spreading the adhesive by power storage stack 10 to form adhesive layer 40 so as to protrude from receiving surface 24a can reduce a pressing load loss. Thus, power storage stack 10 can be sufficiently pressed against bottom wall portion 23.

Power storage stack 10 may have a bottom portion with irregularities formed as the plurality of power storage cells 11 have their bottom surface portions offset in level. Even in such a case, by pressing power storage stack 10 against bottom wall portion 23, as described above, the adhesive can be deformed to follow the irregularities. Thereby, adhesive layer 40 can be brought into close contact with the bottom portion of power storage stack 10, and good thermal conductivity can be ensured.

Further, bottom wall portion 23 having receiving portion 24 and lower wall portion 25 different in level is increased in rigidity. This can suppress deformation of bottom wall portion 23 when power storage stack 10 is pressed against and fixed to bottom wall portion 23.

In addition, when dew condensation occurs in accommodation case 20, dew condensation water moves to lower wall portion 25 located at a position lower in level than receiving surface 24a. This can suppress short circuit of power storage stack 10 on receiving surface 24a due to dew condensation water.

### (Second Embodiment)

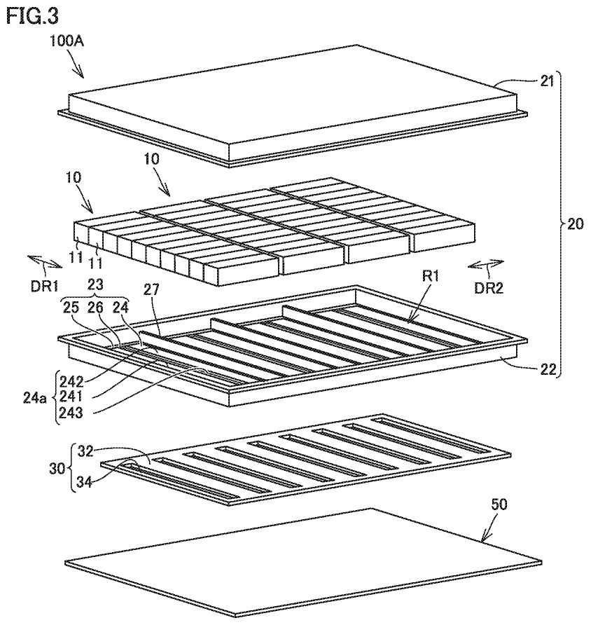

FIG. 3 is an exploded perspective view of a power storage device according to a second embodiment. FIG. 4 is a cross section of the power storage device according to the second embodiment on the side of a bottom wall portion of an accommodation case. A power storage device 100A according to the second embodiment will now be described with reference to FIGS. 3 and 4.

As shown in FIGS. 3 and 4, power storage device 100A according to the second embodiment differs from power storage device 100 according to the first embodiment in the shape of receiving portion 24 and the configuration of cooler 30. The remainder in configuration is substantially the same as that of the first embodiment.

In each of partitioned regions R1, receiving surface 24a includes a first portion 241, a second portion 242, and a recess 243.

First portion 241 receives one side of power storage stack 10 in intersecting direction DR2. Second portion 242 receives the other side of power storage stack 10 in intersecting direction DR2. Recess 243 is provided between first portion 241 and second portion 242. Recess 243 is provided to be continuous from one end to the other end of receiving surface 24a in alignment direction DR1.

Further, in the second embodiment, in each partitioned region R1, lower wall portion 25 is provided so as to surround receiving surface 24a when viewed from above.

Cooler 30 differs from that of the first embodiment in the number of cooling portions 32. The plurality of cooling portions 32 are provided so as to correspond to first portion 241 and second portion 242 in each partitioned region R1. The plurality of cooling portions 32 are in thermal contact via a thermally conductive layer 60 with back surface 24b of a portion facing away from first portion 241 and second portion 242. As thermally conductive layer 60, for example, silicone resin, acrylic resin, epoxy resin, or the like can be used. Thermally conductive layer 60 may be dispensed with.

In the second embodiment as well, adhesive layer 40 has a portion disposed between first and second portions 241 and 242 and power storage stack 10, and protruding portion 42 protruding from receiving surface 24a to connecting portion 26, and substantially the same effect as in the first embodiment can be obtained.

In addition, when fixing power storage stack 10, an adhesive member is applied to first portion 241 and second portion 242, and when pressing power storage stack 10 toward bottom wall portion 23, air can escape to a gap S between recess 243 and power storage stack 10. This can suppress formation of an air layer between power storage stack 10 and adhesive layer 40. This can in turn suppress a decrease in heat transfer efficiency.

Although the embodiments of the present disclosure have been described, it should be considered that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage device comprising:
a power storage stack;
an accommodation case that has a bottom wall portion and accommodates the power storage stack; and
an adhesive layer that has thermal conductivity and fixes the power storage stack to the bottom wall portion,
the bottom wall portion including a receiving portion that has a receiving surface on which the power storage stack is received, a lower wall portion located at a position lower in level than the receiving surface, and a connecting portion that interconnects the receiving portion and the lower wall portion,
the adhesive layer including a portion disposed between the receiving surface and the power storage stack, and a protruding portion that protrudes from the receiving surface to the connecting portion.

2. The power storage device according to claim 1, wherein
the power storage stack includes a plurality of power storage cells aligned in an alignment direction, and
the receiving surface includes a first portion on which the power storage stack has one side received in an intersecting direction intersecting the alignment direction, a second portion on which the power storage stack has the other side received in the intersecting direction, and a recess provided between the first portion and the second portion.

3. The power storage device according to claim 1, further comprising a cooler that is disposed outside the accommodation case and cools the power storage stack, wherein
the cooler includes a cooling portion having a cooling channel through which a cooling medium passes, and
the cooling portion is disposed in thermal contact with a back surface of the receiving portion facing away from the receiving surface.
